(19) United States
(12) Patent Application Publication
(10) Pub. No.: US 2019/0094865 A1
(43) Pub. Date: Mar. 28, 2019

(54) AUTONOMOUS VEHICLE CONTROL SYSTEMS AND METHODS OF OPERATING A VEHICLE USING THE SAME

(71) Applicant: Toyota Research Institute, Inc., Los Altos, CA (US)

(72) Inventor: Luke S. Fletcher, Cambridge, MA (US)

(73) Assignee: Toyota Research Institute, Inc., Los Altos, CA (US)

(21) Appl. No.: 16/142,446

(22) Filed: Sep. 26, 2018

Related U.S. Application Data
(60) Provisional application No. 62/563,839, filed on Sep. 27, 2017.

(51) Int. Cl. G05D 1/02; G05D 1/00; G01C 21/26

(52) U.S. Cl. CPC G05D 1/0212; G05D 1/0088; G05D 2201/0213; G01C 21/26; G05D 1/0274

(57) ABSTRACT

An autonomous vehicle control system that determines, using a location device, an individual roadway segment on which a vehicle is located, accesses, using one or more processors, a confidence score associated with the individual roadway segment, outputs one or more vehicle control signals from an automated drive controller communicatively coupled to the vehicle, which are based on one or more vehicle control settings of an individual autonomous operation profile associated with the confidence score, and operates the vehicle based on the one or more vehicle control signals output by the automated drive controller.

### CROSS-REFERENCE TO RELATED APPLICATIONS

This application claims the benefit of and priority to U.S. Provisional Application No. 62/563,839 filed Sep. 27, 2017, the details of which are incorporated by reference in their entirety.

### TECHNICAL FIELD

Embodiments described herein generally relate to autonomous vehicle control systems and, more specifically, methods and systems for operating a vehicle using autonomous vehicle control systems.

### BACKGROUND

Vehicles exist that are capable of driving either completely autonomously or partially autonomously and may monitor and store data regarding the vehicle operating environment in which the vehicle is operating. However, these autonomous vehicles often operate in the same manner, regardless of how much information the vehicle is able to access about the environment in which the vehicle is operating (e.g., stored data). For example, in a vehicle operating environment about which the autonomous vehicle contains a small amount of data, the autonomous vehicle may autonomously operate in an overly aggressive manner and in a vehicle operating environment about which the autonomous vehicle contains a large amount of data, the autonomous vehicle may operate in an overly conservative manner.

Accordingly, a need exists for systems and methods for altering and customizing autonomous operations of a vehicle based on monitored and stored data regarding a vehicle operating environment.

### SUMMARY

In one embodiment, an autonomous vehicle control system includes one or more processors, a location device communicatively coupled to the one or more processors, one or more memory modules communicatively coupled to the one or more processors, and a plurality of autonomous operation profiles stored in the one or more memory modules. Each of the plurality of autonomous operation profiles includes one or more vehicle control settings for an automated drive controller communicatively coupled to a vehicle. The autonomous vehicle control system also includes a plurality of confidence scores stored in the one or more memory modules. The plurality of confidence scores are associated with the plurality of roadway segments such that the autonomous vehicle control system includes a confidence score for each individual roadway segment of the plurality of roadway segments and each confidence score is associated with an individual autonomous operation profile of the plurality of autonomous operation profiles. Further, the autonomous vehicle control system includes machine readable instructions stored in the one or more memory modules that cause the autonomous vehicle control system to perform at least the following when executed by the one or more processors: determine, using the location device, an individual roadway segment on which the vehicle is located, access, using the one or more processors, a confidence score associated with the individual roadway segment, output one or more vehicle control signals from the automated drive controller, wherein the one or more vehicle control signals are based on one or more vehicle control settings of an individual autonomous operation profile associated with the confidence score, and operate the vehicle based on the one or more vehicle control signals output by the automated drive controller.

In another embodiment, a method of operating a vehicle includes determining, using a location device communicatively coupled to one or more processors, an individual roadway segment on which the vehicle is located and accessing, using the one or more processors, a confidence score associated with the individual roadway segment. The confidence score is stored in one or more memory modules communicatively coupled to the one or more processors. The method also includes outputting one or more vehicle control signals from an automated drive controller communicatively coupled to the vehicle. The one or more vehicle control signals are based on one or more vehicle control settings of an individual autonomous operation profile associated with the confidence score. Further, the method includes operating the vehicle based on the one or more vehicle control signals output by the automated drive controller.

In yet another embodiment, a method of operating a vehicle includes monitoring, using one or more observation sensors communicatively coupled to one or more processors and one or more memory modules, a vehicle operating environment of a vehicle as the vehicle travels along a first roadway segment located in the vehicle operating environment, outputting a sensor signal comprising roadway information regarding the vehicle operating environment from the one or more observation sensors, such that the roadway information is received by the one or more memory modules, and storing the roadway information in the one or more memory modules. The one or more memory modules also store a plurality of autonomous operation profiles, each comprising one or more vehicle control settings for an automated drive controller communicatively coupled to the vehicle and a plurality of confidence scores associated with a plurality of roadway segments. Further, an individual confidence score is associated with each individual roadway segment of the plurality of roadway segments such that a first confidence score is associated with the first roadway segment and each confidence score is associated with an individual autonomous operation profile of the plurality of autonomous operation profiles. The method also includes increasing the first confidence score based on the roadway information regarding the vehicle operating environment of the first roadway segment such that the first confidence score is a first updated confidence score.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an autonomous vehicle control system, according to one or more embodiments shown and described herein;

FIG. 2 schematically depicts an example vehicle operating environment including a plurality of roadway segments, according to one or more embodiments shown and described herein;

FIG. 3 schematically depicts an example vehicle roadway portion of an individual roadway segment of FIG. 2, according to one or more embodiments shown and described herein;

FIG. 4A graphically depicts an example autonomous acceleration operation profile of the autonomous vehicle control system of FIG. 1, according to one or more embodiments shown and described herein;

FIG. 4B graphically depicts an example autonomous deceleration operation profile of the autonomous vehicle control system of FIG. 1, according to one or more embodiments shown and described herein; and

FIG. 5 graphically depicts a range of confidence scores of the autonomous vehicle control system, according to one or more embodiments shown and described herein.

### DETAILED DESCRIPTION

The embodiments disclosed herein include an autonomous vehicle control system for a vehicle having autonomous operation capability, for example, full autonomous operation capability or partial autonomous operation capability. The vehicle includes an automated drive controller for providing one or more vehicle control signals to a vehicle control system to control the acceleration, speed, and/or direction of travel of the vehicle during autonomous operation. The vehicle control signals may be based on one of a plurality of autonomous operation profiles stored within the autonomous vehicle control system. Each autonomous operation profile includes vehicle control settings that control the instructional content of at least some of the vehicle control signals output by the automated drive controller and received by the vehicle control system.

In operation, when the autonomous vehicle travels along one or more roadway segments autonomously, the acceleration, speed, and/or direction of travel of the vehicle may be dictated by the autonomous operation profile. Further, the vehicle may include a confidence score associated with each of the one or more roadway segments. As the vehicle becomes more familiar with a particular roadway segment, for example, by monitoring the roadway segment, the area surrounding the roadway segment, and the vehicle itself, using one or more observation sensors during repeated autonomous or manual operation of the vehicle along the particular roadway segment, the confidence score increases. Further, during autonomous operation of the vehicle, the autonomous operation profile may be selected based on the confidence score associated with the roadway segment. For example, the vehicle may operate autonomously using a more aggressive autonomous operation profile when traveling on a roadway segment associated with a high confidence score and may operate autonomously using a more conservative autonomous operation profile when traveling on a roadway segment associated with a low confidence score. In other words, as the vehicle becomes more familiar with one or more roadway segments, the vehicle operates more aggressively along these more familiar roadway segments.

For example, each weekday, the vehicle may be operated (autonomously or driver operated) on a daily commute (e.g., back and forth between the driver's home to the driver's workplace) and the observation sensors may monitor the roadway segments traveled during the daily commute, allowing the autonomous vehicle control system to store roadway information regarding these roadway segments. Over time, the vehicle becomes increasingly familiar with the roadway segments of the daily commute and the confidence score associated with each of these roadway segments may increase. Thus, over time, the vehicle may autonomously operate along the roadway segments of the daily commute with an increasingly aggressive autonomous operation profile. Conversely, when the vehicle travels along a roadway segment for the first time, for example, on a road trip, the autonomous vehicle control system has a limited amount of roadway information about this roadway segment and thus may autonomously operate along this roadway segment with a conservative autonomous operation profile. The autonomous vehicle control system and will now be described in more detail herein with specific reference to the corresponding drawings.

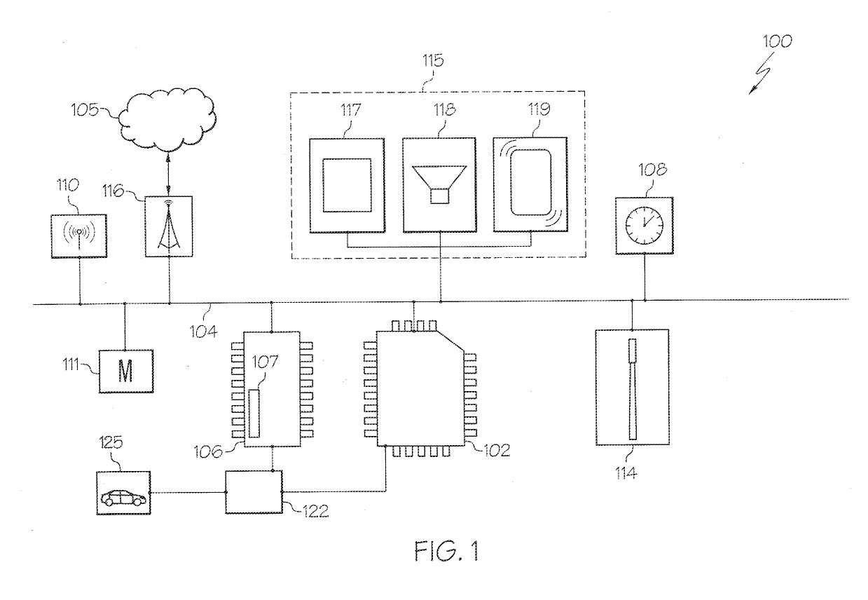

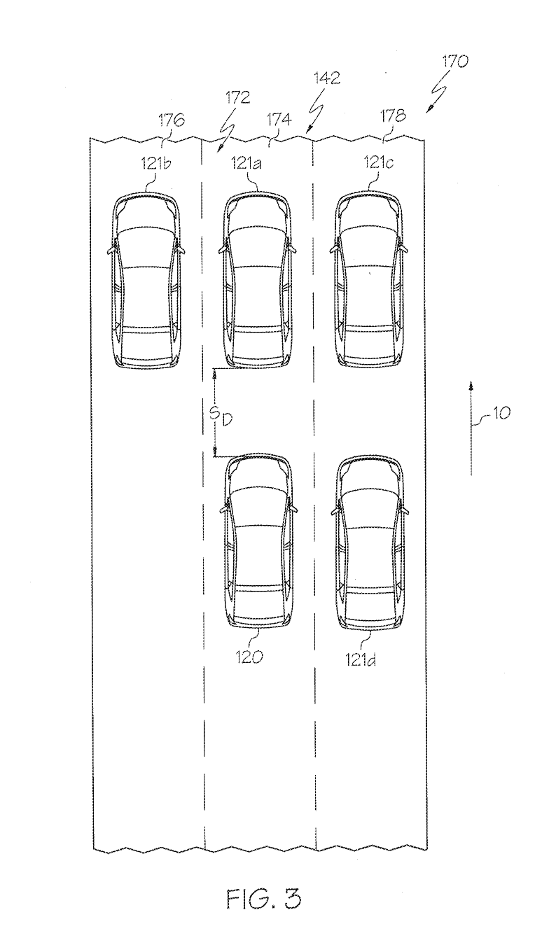

Referring now to FIG. 1, an embodiment of an autonomous vehicle control system 100 is schematically depicted. It is noted that, while the autonomous vehicle control system 100 is depicted in isolation, some or all of the components of the autonomous vehicle control system 100 may be included within a vehicle 120, which is depicted in FIG. 3. As depicted in FIG. 1, the autonomous vehicle control system 100 includes one or more processors 102. Each of the one or more processors 102 may be any device capable of executing machine readable instructions. Accordingly, each of the one or more processors 102 may be a controller, an integrated circuit, a microchip, a computer, or any other computing device. The one or more processors 102 are coupled to a communication path 104 that provides signal interconnectivity between various components of the autonomous vehicle control system 100. Accordingly, the communication path 104 may communicatively couple any number of processors 102 with one another, and allow the components coupled to the communication path 104 to operate in a distributed computing environment. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth, and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Accordingly, the communication path 104 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Moreover, the autonomous vehicle control system 100 includes one or more memory modules 106 coupled to the communication path 104. The one or more memory modules 106 may comprise RAM, ROM, flash memories, hard drives, or any device capable of storing machine readable instructions such that the machine readable instructions can be accessed by the one or more processors 102. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 106. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

As depicted in FIG. 1, the autonomous vehicle control system 100 may further comprise a location device 114, such as a satellite antenna, coupled to the communication path 104 and configured to locate the vehicle 120, for example, by receiving signals from global positioning system satellites. For example, the location device 114 may include one or more conductive elements that interact with electromagnetic signals transmitted by global positioning system satellites. The received signal is transformed into a data signal indicative of the location of the location device 114 or an object positioned near the location device 114, by the one or more processors 102. In other embodiments, the location device 114 may comprise electro-optic sensors, infrared sensors, RF sensors, imaging sensors, or the like. For example the location device 114 may locate the vehicle 120 using control plane locating, by tracking one or more mobile devices of the driver, or any other known or yet to be developed method of locating a vehicle 120. Further, in embodiments in which the vehicle 120 is located using a mobile device of the driver, this mobile device may be the “location device 114.” As used herein, “location” means a unique geographic coordinate defined with reference to a coordinate system, such as a geographic location defined by a particular latitude and longitude. Further, in embodiments where the location device 114 comprises a satellite antenna coupled to the vehicle 120, the one or more processors 102 execute machine readable instructions to transform the global positioning satellite signals received by the satellite antenna into data indicative of the current location of the vehicle 120.

Moreover, the autonomous vehicle control system 100 may comprise a clock 108 coupled to the communication path 104. The clock 108 may provide time of day signals and calendar signals (e.g., month/day/year data, day of the week data, holiday data, or the like) to the processors 102 and other components of the autonomous vehicle control system 100. As described below, the autonomous vehicle control system 100 may operate differently on different days, and/or at different times of a day.

Still referring to FIG. 1, in some embodiments, the autonomous vehicle control system 100 includes a network 105, for example, one or more computer networks (e.g., a personal area network, a local area network, or a wide area network), cellular networks, satellite networks and/or a global positioning system and combinations thereof. Example local area networks may include wired Ethernet and/or wireless technologies such as, for example, wireless fidelity (Wi-Fi). Moreover, example personal area networks may include wireless technologies such as, for example, IrDA, Bluetooth, Wireless USB, Z-Wave, ZigBee, and/or other near field communication protocols, and/or wired computer buses such as, for example, USB and FireWire. Suitable cellular networks include, but are not limited to, technologies such as LTE, WiMAX, UMTS, CDMA, and GSM.

Still referring to FIG. 1, the autonomous vehicle control system 100 comprises network interface hardware 116 for communicatively coupling the autonomous vehicle control system 100 to the network 105. The network interface hardware 116 can be communicatively coupled to the communication path 104 and can be any device capable of transmitting and/or receiving data via a network. Accordingly, the network interface hardware 116 can include a communication transceiver for sending and/or receiving any wired or wireless communication. For example, the network interface hardware 116 may include an antenna, a modern, LAN port, Wi-Fi card, WiMax card, mobile communications hardware, near-field communication hardware, satellite communication hardware, hardware configured to operate in accordance with the Bluetooth wireless communication protocol, and/or any wired or wireless hardware for communicating with other networks and/or devices.

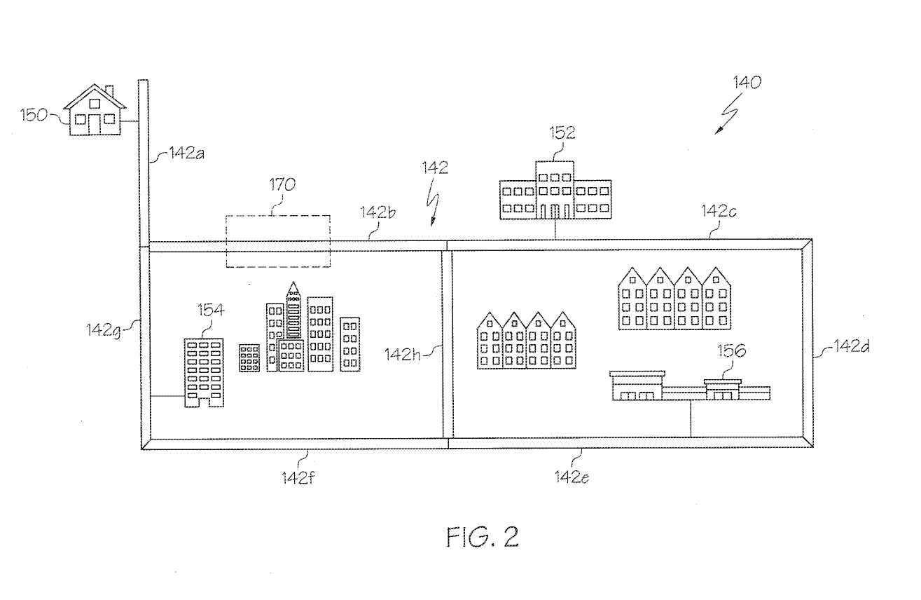

Still referring to FIG. 1, the autonomous vehicle control system 100 further comprises one or more observation sensors 110 coupled to the vehicle 120 and communicatively coupled to the communication path 104. The one or more observation sensors 110 may comprise any sensor or combination of sensors configured monitor a vehicle operating environment 140 (FIG. 2) and output sensor signals comprising data regarding the vehicle operating environment 140, such as one or more roadway segments 142 of the vehicle operating environment 140 including objects and conditions on the one or more roadway segments 142 and near the one or more roadway segments 142 (e.g., surrounding the one or more roadway segments 142). The observation sensors 110 may also monitor the vehicle 120 and occupants of the vehicle 120 (such as the driver of the vehicle 120) and may output sensors signals regarding the vehicle 120 and the occupants of the vehicle 120. In operation, the observation sensors 110 may help the vehicle 120 navigate autonomously and may help the vehicle 120 learn additional information regarding the vehicle operating environment 140.

The one or more observation sensors 110 may include proximity sensors, cameras, laser scanners, capacitive displacement sensors, Doppler effect sensors, eddy-current sensors, ultrasonic sensors, magnetic sensors, optical sensors, radar sensors, sonar sensors, lidar sensors, vibration sensors, or combinations thereof. For example, the one or more observation sensors 110 may detect and output sensor signals regarding objects near the roadway segment 142 (e.g., objects in the shoulder), vehicles or other objects on the roadway segment 142, the condition of the roadway segment 142, and the driver within the vehicle 120. Further, the autonomous vehicle control system 100 may include one or more moisture sensors 111 coupled to the vehicle 120 and communicatively coupled to the communication path 104. The one or more moisture sensors 111 are configured to determine the presence of moisture, which may help the autonomous vehicle control system 100 determine the present weather condition (e.g., determine whether it is raining).

Referring still to FIG. 1, the autonomous vehicle control system 100 may further comprise one or more feedback devices 115 communicatively coupled to the communication path 104 and the one or more processors 102. The one or more feedback devices 115 may comprise any device configured to provide feedback to one or more occupants of the vehicle 120, for example, the driver of the vehicle 120. As shown in FIG. 1, the one or more feedback devices 115 may comprise one or more of a visual feedback device 117 configured to provide visual feedback, an audible feedback device 118 configured to provide audible feedback, and a tactile feedback device 119 configured to provide tactile and/or haptic feedback.

The visual feedback device 117 may comprise any device configured to provide visual feedback. For example, the visual feedback device 117 may comprise a display, for example, the display portion of a human machine interface (HMI) of the vehicle 120, such as an infotainment interface, and in operation, the display may provide maps, navigation, entertainment, autonomous operation information, or a combination thereof. The visual feedback device 117 may include any medium capable of transmitting an optical output such as, for example, a cathode ray tube, light emitting diodes, a liquid crystal display, a plasma display, or the like. Moreover, the visual feedback device 117 may be a touchscreen that, in addition to providing optical information, detects the presence and location of a tactile input upon a surface of or adjacent to the surface of the visual feedback device 117. Further, the visual feedback device 117 may comprise one or a combination of lights, for example, lights positioned on a dashboard of the vehicle 120, and may provide visual feedback by displaying different colors, flashing sequences, letter or number displays, or the like. Some embodiments may not include the visual feedback device 117 and some embodiments may include multiple visual feedback devices 117.

The audible feedback device 118 may comprise any device configured to provide audible feedback and may be positioned in the vehicle 120. The audible feedback device 118 transforms data signals from the one or more processors 102 into audible signals. In some embodiments, the audible feedback device 118 may be configured as speakers capable of receiving auditory signals from the processor 102 (either directly or indirectly from other hardware, such as amplifiers, drivers, digital-to-analog converters, and the like) to produce auditory messages capable of being heard by one or more occupants of the vehicle 120, for example, the driver. In some embodiments, the audible feedback device 118 includes a first speaker and a second speaker so that the auditory message is provided in stereo. For example, the audible feedback devices 118 may comprise the one or more speakers of a speaker system of the vehicle 120. In some embodiments, the audible feedback device 118 may comprise headphones, earbuds, or the like. Further, some embodiments may not include the audible feedback device 118 and some embodiments may include multiple audible feedback devices 118.

The tactile feedback device 119 may comprise any device configured to provide tactile and/or haptic feedback. The tactile feedback device 119 may be positioned in the vehicle 120 in a variety of locations such that tactile and/or haptic feedback output by the tactile feedback device may be perceptible to one or more occupants of the vehicle 120, such as the driver. For example, the tactile feedback device 119 may be positioned on or in one or more seats of the vehicle 120, such as a driver's seat, on or in a steering wheel, and one or in the floor, dashboard, seat belt, or any other location from which the tactile feedback device 119 may output perceptible tactile and/or haptic feedback. The tactile feedback device 119 may include a vibration device (such as in embodiments in which tactile feedback is delivered through vibration), an air blowing device (such as in embodiments in which tactile feedback is delivered through a puff of air), or a pressure generating device (such as in embodiments in which the tactile feedback is delivered through generated pressure). Some embodiments may not include a tactile feedback device 119 and some embodiments may include multiple tactile feedback devices 119.

Referring now to FIG. 2, the vehicle operating environment 140 is depicted to provide illustrative context for the various functions of the autonomous vehicle control system 100, described herein. The vehicle operating environment 140 depicts a plurality of roadway segments 142 and a plurality of points of interest, such as a home 150 (for example, a driver's home), a school 152, a workplace 154, and a shopping center 156. As used herein, “roadway segment” means an ordered series of locations along a roadway and “route” or “trip” refers to an ordered series of roadway segments 142. For example, an individual roadway segment 142 may comprise a series of locations between turns, a series of locations between intersections, a series of locations along a certain distance of the roadway, or the like. In some embodiments, each individual roadway segment 142 may comprise the same distance and in other embodiments, some or all of the individual roadway segments 142 may comprise different distances. For example, individual roadway segments 142 may comprise a distance of about 10 km, 5 km, 1 km, 500 m, 250 m, 100 m, 50 m, 25 m, 10 m, 5 m, 1 m, or the like. Further, for illustrative purposes, the vehicle operating environment 140 depicted in FIG. 2 comprises eight individual roadway segments 142: a first roadway segment 142a, a second roadway segment 142b, a third roadway segment 142c, a fourth roadway segment 142d, a fifth roadway segment 142e, a sixth roadway segment 142f, a seventh roadway segment 142g, and an eighth roadway segment 142a

Further, FIG. 2 depicts a roadway section 170 of an individual roadway segment 142 (e.g. the second roadway segment 142b) and the roadway section 170 is depicted in more detail in FIG. 3. In particular, FIG. 3 depicts the vehicle 120 and one or more neighboring vehicles 121 located on the individual roadway segment 142. The roadway section 170 also shows that the individual roadway segment 142 may comprise one or more lanes 172, for example, a first lane 174, a second lane 176, and a third lane 178. Further, the vehicle 120 is depicted in the first lane 174 and positioned a separation distance S_{D} from a first neighboring vehicle 121a, which is located in front of the vehicle 120 (with respect to a traveling direction 10) and in the same lane (the first lane 174) as the vehicle 120. FIG. 3 also depicts a second neighboring vehicle 121b positioned in the second lane 176, and both a third and fourth neighboring vehicle 121c, 121d, each positioned in the third lane 178.

Referring now to FIGS. 1-3, the vehicle 120 and the one or more neighboring vehicles 121 may comprise automobiles or any other passenger and or non-passenger vehicles. Further, the vehicle 120 comprises autonomous operation capability, for example, full autonomous operation capability or partial autonomous operation capability, such that the vehicle 120 may navigate one or more roadway segments 142 with limited human input or without human input. The vehicle 120 comprises a frame, one or more wheels, and a vehicle control system 125 (FIG. 1) that may include an engine system, steering system, transmission system, braking system, and any other components for controlling the acceleration, deceleration, speed, and/or direction of travel of the vehicle 120.

Further, an automated drive controller 122 is communicatively coupled to the vehicle control system 125. In operation, the automated drive controller 122 provides one or more vehicle control signals to the vehicle control system 125 to control the acceleration, speed, and/or direction of travel of the vehicle 120 by controlling one or more systems of the vehicle control system 125, such as the engine system, steering system, transmission system, braking system, or the like. In some embodiments, the automated drive controller 122 is a component of the vehicle 120 and in other embodiments, the automated drive controller 122 is positioned apart from the vehicle 120 and is communicatively coupled to the vehicle control system 125 of the vehicle 120 using a wireless connection. Further, the automated drive controller 122 may be communicatively coupled to the one or more processors 102 and the one or more memory modules 106 and, in some embodiments, may include at least one of the one or more processors 102 and at least one of the one or more memory modules 106. In operation, the automated drive controller 122 may output one or more vehicle control signals to the vehicle control system 125. The one or more vehicle control signals of the automated drive controller 122 may comprise an acceleration control signal which includes instructions regarding a desired acceleration rate of the vehicle 120 and a deceleration control signal which includes instructions regarding a desired deceleration rate of the vehicle 120.

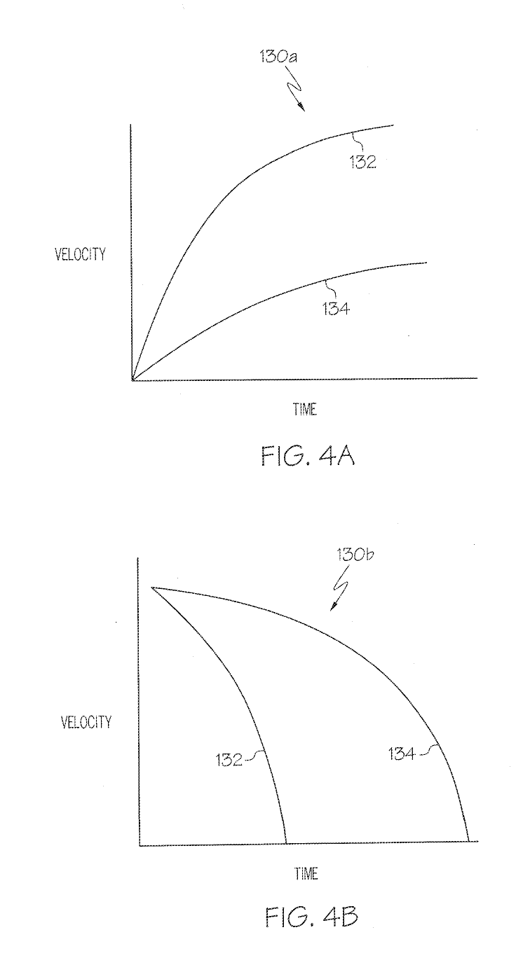

Referring now to FIGS. 4A and 4B, the vehicle control signals may be based, at least in part, on an autonomous operation profile 130. The autonomous operation profile 130 comprises vehicle control settings that control the instructional content of at least some of the vehicle control signals output by the automated drive controller 122 and received by the vehicle control system 125. For example, the autonomous operation profile 130 may comprise vehicle control settings specifying the acceleration rate or acceleration operation profile and the deceleration rate or deceleration operation profile such that the vehicle control signals output by the automated drive controller 122 instruct the vehicle control system 125 to implement an autonomous operation based on the autonomous operation profile 130. As used herein, “acceleration rate” and “deceleration rate” refer to a linear acceleration rate and a linear deceleration rate, respectively, as well as an angular acceleration rate and an angular deceleration rate, respectively. For example, when the vehicle 120 is operating with a high acceleration rate or deceleration rate, the vehicle may change speed at a high rate of change and may change direction with a high rate of change. Further, when the vehicle is operating with a low acceleration rate or deceleration rate, the vehicle may change speed at a low rate of change and may change direction with a low rate of change. To illustrate, when the vehicle 120 is operating at a high acceleration rate, the vehicle both accelerated quickly from a stop and changes lanes quickly (i.e. more aggressively).

As depicted in FIGS. 4A and 4B, the autonomous vehicle control system 100 may comprise multiple autonomous operation profiles 130, each comprising different vehicle control settings, for example, an aggressive autonomous operation profile 132 and a conservative autonomous operation profile 134. In operation, the aggressive autonomous operation profile 132 comprises vehicle control settings specifying a high acceleration rate and a high deceleration rate and the conservative autonomous operation profile 134 comprises vehicle control settings specifying a low acceleration rate and a low deceleration rate. As graphically depicted in FIG. 4A, a magnitude of the aggressive acceleration rate is greater than a magnitude of the conservative acceleration rate. Moreover, as graphically depicted in FIG. 4B, a magnitude of the aggressive deceleration rate is greater than a magnitude of the conservative deceleration rate.

Further, the autonomous operation profile 130 may include an autonomous acceleration operation profile 130a (FIG. 4A) comprising vehicle control settings regarding acceleration and an autonomous deceleration operation profiles 130b (FIG. 4B) comprising vehicle control settings regarding deceleration. In operation, the autonomous acceleration operation profile 130a may be different than the autonomous deceleration operation profile 130b, for example, the autonomous acceleration operation profile 130a may be an aggressive autonomous operation profile 132 and the autonomous deceleration operation profile 130b may be a conservative autonomous operation profile 134. Further, a single autonomous operation profile 130 may control both the acceleration and deceleration of the vehicle 120.

Further, the autonomous operation profile 130 may also comprise vehicle control settings that specify a desired separation distance S_{D} between the vehicle 120 and a neighboring vehicle 121 positioned in front of the vehicle 120 and in the same lane 172 as the vehicle 120 (e.g., the first neighboring vehicle 121a depicted in FIG. 3). In particular, the automated drive controller 122 may operate based on the autonomous operation profile 130 and output vehicle control signals to the vehicle control system 125, such that the vehicle control system 125 automatically adjusts the speed of the vehicle 120 to maintain the separation distance S_{D} between the vehicle 120 and the neighboring vehicle 121. In operation, the aggressive autonomous operation profile 132 may specify a shorter separation distance S_{D} than the conservative autonomous operation profile 134. While the autonomous operation profile 130 is described above as comprising vehicle control settings that specify acceleration rates, deceleration rates, and the separation distance S_{D}, it should be understood that the autonomous operation profile 130 may comprise vehicle control settings that specify any type of autonomous operation, such as, without limitation, lane change settings (e.g., the frequency of lane changes, speed of the vehicle 120 when changing lanes, the minimum clearance between the vehicle 120 and neighboring vehicles 121 required before changing lanes, or the like) and passing settings (e.g., the frequency of passing, the speed and acceleration of the vehicle 120 when passing, the minimum allowable clearance time between the vehicle 120 and an oncoming vehicle when passing, or the like).

The aggressive autonomous operation profile 132 and the conservative autonomous operation profile 134 are depicted as illustrative examples of autonomous operation profiles 130, however, it should be understood that any number of autonomous operation profiles 130 are contemplated. For example, the memory modules 106 may store a continuum of autonomous operation profiles 130, ranging from autonomous operation profiles which comprise vehicle control settings that correspond to low magnitude acceleration and deceleration rates and long separation distances S_{D} to autonomous operation profiles which comprise vehicle control settings that correspond to high magnitude acceleration and deceleration rates and short separation distances S_{D}. Further, each of the plurality of autonomous operation profiles 130 may each comprise incrementally different vehicle control settings, such that a continuum of vehicle control settings may be used to implement a continuum of vehicle control signals.

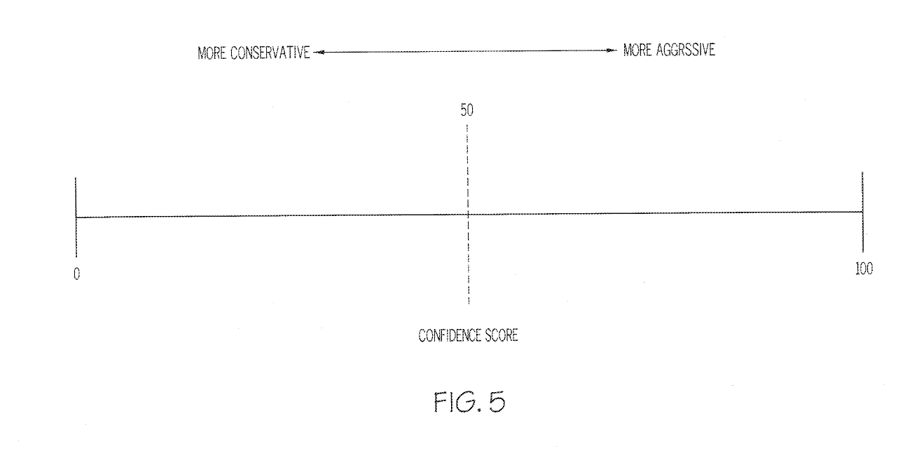

Referring now to FIGS. 1-5, the autonomous operation profile 130 may be selected for implementation by the one or more processors 102 during an autonomous operation of the vehicle 120 based on a confidence score stored in the one or more memory modules 106 and associated with an individual roadway segments 142 on which the vehicle 120 is located. As depicted in FIG. 5, the confidence score comprises a scalar value that defines how familiar the vehicle 120 is with an individual roadway segment 142. In particular, the confidence score is a scalar value that corresponds to roadway information stored in the one or more memory modules 106 regarding the individual roadway segment 142. In operation, higher confidence scores correspond with autonomous operation profiles 130 that are more aggressive and lower confidence scores correspond with autonomous operation profiles 130 that are more conservative. While FIG. 5 depicts a scalar range of 0-100 to illustrate a range of confidence scores, other ranges are contemplated, for example, 0-1000, 0-10000, or the like, which may allow for more precise increments of confidence scores.

In some embodiments, the confidence score may comprise a baseline confidence score (e.g., the confidence score before any additional roadway information regarding the individual roadway segment 142 is stored in the one or more memory modules 106) or an updated confidence score, which is increased from the baseline confidence score based on additional roadway information received from the one or more observation sensors 110 and stored in the one or more memory modules 106. In some embodiments, the autonomous vehicle control system 100 includes a threshold confidence score (e.g., a confidence score of 50, as depicted in FIG. 5), which comprises a confidence score that at or above which the vehicle 120 operates using the aggressive autonomous operation profile 132 and below which the vehicle 120 operates using the conservative autonomous operation profile 134. Further, in some embodiments, each individual roadway segment 142 may have a different confidence score for each heading of the individual roadway segment 142 (e.g., each direction on the roadway, such as a northbound direction and a southbound direction, an eastbound direction and a westbound direction, or the like) and/or each lane 172 of the individual roadway segment 142.

Referring still to FIGS. 1-5, the one or more memory modules 106 comprise a roadway information database 107 (FIG. 1) that stores roadway information pertaining to the plurality of roadway segments 142, such as geographical information (e.g., map information) and operating condition information. Geographical information stored in the roadway information database 107 may include the location of each roadway segment 142 (e.g., the latitude and longitude of each roadway segment 142), the distance of each roadway segment 142, the dimensions of each roadway segment 142 (e.g., the number of lanes, the width of each lane, the presence and width of a shoulder, or the like), and topographical information regarding the roadway segment 142. Further, operating condition information stored in the roadway information database 107 may include additional details of the roadway segment 142 beyond mere geographical information. For example, operating condition information may include information regarding the physical roadway surface and information regarding objects on or near the roadway, for example, a bridge, one or more trees or other vegetation, or construction equipment, a barrier wall (e.g., a Jersey barrier), or the like. Further, operating condition information may comprise information regarding the behavior of the vehicle occupant(s) (e.g., the driver of the vehicle 120) when the vehicle 120 is located on the individual roadway segment 142 As described in more detail below, additional operating condition information may be stored in the roadway information database 107 based on sensors signals output by the one or more observation sensors 110.

The roadway information database 107 is a dynamic database that stores roadway information (e.g., both geographical information and operating condition information) based on sensor data received from the one or more observation sensors 110. In operation, the one or more observation sensors 110 may monitor the vehicle operating environment 140, as the vehicle 120 travels along an individual roadway segment 142, and may output sensor signals data to provide roadway information to the one or more memory modules 106, such that this additional roadway information may be stored in the roadway information database 107. This additional stored roadway information may increase the confidence score associated with the individual roadway segment 142. In other words, the autonomous vehicle control system 100 learns more about the vehicle operating environment 140 in which the individual roadway segment 142 is located, the confidence score associated with the individual roadway segment 142 increases.

For example, when the vehicle 120 travels along an individual roadway segment 142 the first time or for the first few times (either in a driver controlled mode or an autonomous operation mode) the one or more observation sensors 110 monitoring the vehicle operating environment 140 may generate false signals based on a misunderstanding of the vehicle operating environment 140. As an illustrative example, the first time the vehicle approaches a bridge that passes over the roadway segment 142, the one or more observation sensors 110 may output sensors signals communicating that an object is present in the roadway segment 142. However, after the vehicle 120 successfully passes under the bridge, the autonomous vehicle control system 100 may determine that this was false signal and may store information regarding the presence of the bridge. Further, this additional roadway information regarding the bridge may increase the confidence score associated with the individual roadway segment 142 such that the next time the vehicle traverses this roadway segment 142 autonomously, the vehicle 120 may operate more aggressively.

Further, the one or more observation sensors 110 may monitor vehicle occupant behavior when the vehicle 120 is located on the individual roadway segment 142, for example, how attentive and/or nervous the driver is when the vehicle 120 is located in the particular roadway segment 142. For example, the one or more observation sensors 110 may monitor the drivers attentiveness by monitoring the drivers gaze (e.g., monitoring how often the driver is looking at or away from to road), monitoring the drivers hand placement on a steering wheel (e.g., whether the drive has one or two hands on the steering wheel), monitoring the drivers grip pressure on the steering wheel, and monitoring one or more physiological features of the driver (e.g., the blood pressure, breathing rate, or the like).

Further, while the confidence score regarding an individual roadway segment 142 increases as the autonomous vehicle control system 100 stores additional roadway information regarding the individual roadway segment 142 in the roadway information database 107, in some embodiments, the confidence score may be temporarily altered based on dynamic conditions, for example, based on temporal information (e.g., time of day, day of the week, or the like), weather information, and and/or traffic information. In embodiments comprising dynamic confidence scores based on temporal information, the time and/or the day of the week may be determined by the clock 108 communicatively coupled to the one or more processors 102 and/or based on access to temporal information, which may be located on one or more servers or databases communicatively coupled to the network 105 and may be accessed using the network interface hardware 116. The confidence score associated with the individual roadway segment 142 may be altered based on the current time and/or the current date. For example, the confidence score may be lower at night than during the day and night may be determined based on a set range of times, sunrise/sunset data, or combinations thereof.

Further, in embodiments comprising dynamic confidence scores based on traffic information, the confidence score associated with the individual roadway segment 142 may be altered based on the current traffic conditions of the individual roadway segment 142. For example, the confidence score may be lower in high traffic scenarios and may incrementally decrease as traffic increases. In some embodiments, the traffic condition may be determined based on access to real time traffic information, which may be located on one or more servers or databases communicatively coupled to the network 105 and may be accessed using the network interface hardware 116. In some embodiments, traffic conditions may be determined based on historical traffic data, which may be stored in the one or more memory modules 106 or located on one or more servers or databases communicatively coupled to the network 105. In some embodiments, the traffic conditions may be determined based on sensor data measured by the observation sensors 110 and/or based on the frequency of braking by the vehicle 120. For example, the one or more observation sensors 110 may be able to detect the presence of one or more neighboring vehicles 121 and detect the relative distance, relative speed, the relative acceleration between the vehicle 120 and the one or more neighboring vehicles 121, and the lane 172 in which each of the one or more neighboring vehicles 121 is located. Further, in some embodiments, the traffic information may comprise information regarding construction zones. When a construction zone is detected, for example based on access to real time traffic information and/or observation of the construction zone by the one or more observation sensors 110, the confidence score may be temporarily lowered.

Further, in embodiments comprising dynamic confidence scores based on weather information, the confidence score associated with the individual roadway segment 142 may be altered based on the current weather conditions at the individual roadway segment 142. For example, the confidence score may be lower in bad weather scenarios (e.g., during precipitation, high wind, or the like) and may incrementally decrease as weather worsens (e.g., as precipitation increases, wind increases, or the like). In some embodiments, the traffic condition may be determined based on access to real time weather information, which may be located on one or more servers or databases communicatively coupled to the network 105 and may be accessed using the network interface hardware 116. In some embodiments, the traffic conditions may be determined based on sensor data measured by the moisture sensors 111, which may measure the presence and amount of precipitation.

Referring again to FIGS. 1-5, the autonomous vehicle control system 100 may implement a method of operating the vehicle 120. In some embodiments, the method may be implemented as logic within the machine readable instructions that, when executed by the one or more processors 102, automatically provides vehicle function instruction. It is noted that, while the method is described as following a specific sequence, additional embodiments of the present disclosure are not limited to any particular sequence.

The method of operating the vehicle 120 first comprises determining, using the location device 114, the location of the vehicle 120. In particular, determining the location of the vehicle 120 comprises determining the individual roadway segment 142 on which the vehicle 120 is located. Next, the method comprises accessing, using the one or more processors 102, the confidence score stored in the one or more memory modules 106 and associated with the individual roadway segment 142. After accessing the confidence score, the autonomous vehicle control system 100 may determine which autonomous operation profile 130 is associated with the confidence score of the individual roadway segment 142. As described above, higher confidence scores are associated with autonomous operation profiles 130 that are more aggressive and lower confidence scores are associated with autonomous operation profiles 130 that are more conservative. For example, in some embodiments, each confidence score may be associated with a different autonomous operation profile 130. Further, in embodiments comprising a threshold confidence score, the method of operating the vehicle 120 may further comprise comparing the confidence score associated with the individual roadway segment 142 on which the vehicle is located with the threshold confidence score and operating the vehicle based on the aggressive autonomous operation profile if the confidence score is at or above the threshold confidence score or operating the vehicle based on the conservative autonomous operation profile is the confidence score is below the threshold confidence score.

After determining which autonomous operation profile 130 is associated with the confidence score of the individual roadway segment 142, the method comprises outputting vehicle control signals from the automated drive controller 122 to the vehicle control system 125 of the vehicle 120 that are based on the one or more vehicle control settings of the autonomous operating profile associated with the confidence score of the individual roadway segment 142. Further, upon receipt of the vehicle control signals, the vehicle control system 125 may autonomously operate the vehicle 120 (e.g., fully or partially autonomously operate the vehicle 120). For example, during partially autonomous operation, the vehicle control system 125 control only some of the systems of the vehicle 120, such as the steering system (in a lane assist operation), the engine system (in an adaptive cruise control operation), or the like Thus, the vehicle 120 may autonomously traverse the individual roadway segment 142 with particular acceleration rates, deceleration rates, separation distances, and the like, based on the confidence score associated with the individual roadway segment 142.

In some embodiments, the method further comprises altering the confidence score associated with the individual roadway segment based on a temporary condition, such as the current time and/or date, the current weather conditions, and/or the current traffic condition. For example, the method may comprise, receiving temporal information, weather information, and/or traffic information and altering the confidence score associated with the roadway segment based on one or more of the temporal information, the weather information, and the traffic information. By altering the confidence score, the vehicle 120 may operate differently based on the current time and/or date, the current weather conditions, and/or the current traffic condition. For example, the confidence score may be temporarily lowered so that the vehicle 120 operates more conservatively in certain conditions, such as, without limitation, nighttime, bad weather, and high traffic.

In some embodiments, the method further includes generating feedback regarding the confidence score associated with the individual roadway segment 142 using the one or more feedback devices 115. As one example, the visual feedback device 117 may display the current confidence score, information regarding the current autonomous operation profile, and/or information generally describing the familiarity and confidence of the vehicle 120 with respect to the individual roadway segment 142. As another example, the audible feedback device 118 may produce auditory messages regarding the current confidence score, information regarding the current autonomous operation profile, and/or information generally describing the familiarity and confidence of the vehicle 120 with respect to the individual roadway segment 142. As another example, the tactile feedback device 119 may produce tactile and/or haptic feedback regarding the current confidence score, information regarding the current autonomous operation profile, and/or information generally describing the familiarity and confidence of the vehicle 120 with respect to the individual roadway segment 142. For example, a single vibration may indicate a low confidence score and a multiple vibration pulses may indicate a high confidence score.

Referring still to FIGS. 1-5, the method of operating the vehicle 120 may also include monitoring the vehicle operating environment 140 using the one or more observation sensors 110, such that the observation sensors 110 may provide sensors signals comprising roadway information regarding the vehicle operating environment 140 to the one or more memory modules 106, which may store this roadway information. Further, when additional roadway information received from the one or more observation sensors 110, the autonomous vehicle control system 100 may update, e.g., increase, the confidence score of the individual roadway segment based on the roadway information received regarding the individual roadway segment. Next, the method includes storing the roadway information in the one or more memory modules 106. Prior to receiving and storing the roadway information, a first confidence score is associated with an individual roadway segment 142. After receiving and storing additional roadway information regarding the individual roadway segment 142, the first confidence score is increased and comprises a first updated confidence score. Thus, the next time the vehicle 120 autonomously travels along the individual roadway segment 142, the vehicle control signals output by the automated drive controller 122 are based on one or more vehicle control settings of an autonomous operation profile associated with the first updated confidence score such that the vehicle autonomously operates more aggressively.

Referring again to FIG. 2, as an illustrative example, the vehicle 120 may travel from the home 150 (located along the first roadway segment 142a) to the workplace 154 (located along the seventh roadway segment 142g). During this trip, the vehicle 120 may travel on the first and the seventh roadway segments 142a and 142g. This is likely a daily trip, thus the first roadway segment 142a and the seventh roadway segments 142g may each have a high confidence score such that when the vehicle 120 operates autonomously on the first or seventh roadway segments 142a and 142g, the vehicle 120 operates based on an autonomous operation profile 130 that is aggressive. On another trip, the vehicle 120 may travel from the home 150 (located along the first roadway segment 142a) to the shopping center 156 (located along the fifth roadway segment 142e) using the first roadway segment 142a, the seventh roadway segment 142g, the sixth roadway segment 142f, and the fifth roadway segment 142e. This may be a less common trip than the trip from the home 150 to the workplace 154. However, the vehicle 120 may still have a high confidence score for the first roadway segment 142a and the seventh roadway segment 142g, due to a daily commute (e.g., home 150 to workplace 154) but may have a lower confidence score for the sixth roadway segment 142f and the fifth roadway segment 142e. As such, the vehicle 120 may autonomously operate more aggressively when traveling on the first and seventh roadway segment 142a, 142g and may autonomously operate more conservatively when traveling on the sixth and fifth roadway segments 142f, 142e.

It should now be understood that embodiments described herein provide for an autonomous vehicle control system that includes a vehicle having autonomous functionality that may autonomously operate more conservatively or aggressively based on a confidence score corresponding to the familiarity of the vehicle with an individual roadway segment on which the vehicle is traveling. The vehicle includes observation sensors that monitor a vehicle operating environment of the individual roadway segment and the autonomous vehicle control system may store roadway information regarding the individual roadway segment. This additional roadway information may increase the confidence score associated with the individual roadway segment. Further, the vehicle may operate autonomously using a more aggressive autonomous operation profile when traveling on a roadway segment associated with a high confidence score and may operate autonomously using a more conservative autonomous operation profile when traveling on a roadway segment associated with a low confidence score.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An autonomous vehicle control system comprising:
one or more processors;
a location device communicatively coupled to the one or more processors;
one or more memory modules communicatively coupled to the one or more processors;
a plurality of autonomous operation profiles stored in the one or more memory modules, wherein each of the plurality of autonomous operation profiles comprise one or more vehicle control settings for an automated drive controller communicatively coupled to a vehicle;
a plurality of confidence scores stored in the one or more memory modules, wherein:
the plurality of confidence scores are associated with the plurality of roadway segments such that the autonomous vehicle control system comprises a confidence score for each individual roadway segment of the plurality of roadway segments; and
each confidence score is associated with an individual autonomous operation profile of the plurality of autonomous operation profiles; and
machine readable instructions stored in the one or more memory modules that cause the autonomous vehicle control system to perform at least the following when executed by the one or more processors:
determine, using the location device, an individual roadway segment on which the vehicle is located;
access, using the one or more processors, a confidence score associated with the individual roadway segment;
output one or more vehicle control signals from the automated drive controller, wherein the one or more vehicle control signals are based on one or more vehicle control settings of an individual autonomous operation profile associated with the confidence score; and
operate the vehicle based on the one or more vehicle control signals output by the automated drive controller.

2. The autonomous vehicle control system of claim 1, wherein the machine readable instructions stored in the one or more memory modules cause the autonomous vehicle control system to perform at least the following when executed by the one or more processors:
increase the confidence score associated with an individual roadway segment upon a second operation of the vehicle along the individual roadway segment.

3. The autonomous vehicle control system of claim 1, further comprising roadway information stored in the one or more memory modules, wherein:
the roadway information comprises information regarding the plurality of roadway segments; and
the confidence score associated with the individual roadway segment is based on the roadway information regarding the individual roadway segment.

4. The autonomous vehicle control system of claim 3, further comprising one or more observation sensors communicatively coupled to the one or more processors and the one or more memory modules, wherein the one or more observation sensors are configured to monitor a vehicle operating environment in which the vehicle and the individual roadway segment is located and output sensor signals comprising roadway information regarding the vehicle operating environment.

5. The autonomous vehicle control system of claim 4, wherein the machine readable instructions stored in the one or more memory modules cause the autonomous vehicle control system to perform at least the following when executed by the one or more processors:
receive a sensor signal from the one or more observation sensors, wherein the sensor signal comprises roadway information regarding the vehicle operating environment; and
increase the confidence score associated with the individual roadway segment based on the roadway information.

6. The autonomous vehicle control system of claim 1, wherein the one or more vehicle control signals comprise an acceleration control signal, a deceleration control signal, or both, that, control an acceleration rate of the vehicle, a deceleration rate of the vehicle, or both.

7. The autonomous vehicle control system of claim 1, wherein the machine readable instructions stored in the one or more memory modules cause the autonomous vehicle control system to perform at least the following when executed by the one or more processors:
compare the confidence score to a threshold confidence score;
operate the vehicle based on an aggressive autonomous operation profile when the confidence score is at or above the threshold confidence score; or
operate the vehicle based on a conservative autonomous operation profile when the confidence score is below the threshold confidence score.

8. The autonomous vehicle control system of claim 7, wherein:
the one or more vehicle control signals comprise an acceleration control signal, a deceleration control signal, or both, that, control an acceleration rate of the vehicle, a deceleration rate of the vehicle, or both; and
a magnitude of the acceleration rate, the deceleration rate, or both, of the vehicle based on the conservative autonomous operation profile is less than a magnitude of the acceleration rate, the deceleration rate, or both, of the vehicle based on the aggressive autonomous operation profile.

9. The autonomous vehicle control system of claim 1, wherein the machine readable instructions stored in the one or more memory modules cause the autonomous vehicle control system to perform at least the following when executed by the one or more processors:
receive temporal information; and
alter the confidence score associated with the individual roadway segment based on the temporal information.

10. The autonomous vehicle control system of claim 1, wherein the machine readable instructions stored in the one or more memory modules cause the autonomous vehicle control system to perform at least the following when executed by the one or more processors:
receive weather information; and
alter the confidence score associated with the individual roadway segment based on the weather information.

11. The autonomous vehicle control system of claim 1, wherein the machine readable instructions stored in the one or more memory modules cause the autonomous vehicle control system to perform at least the following when executed by the one or more processors:
receive traffic information; and
alter the confidence score associated with the individual roadway segment based on the traffic information.

12. The autonomous vehicle control system of claim 1, further comprising one or more feedback devices communicatively coupled to the one or more processors, wherein:
the machine readable instructions stored in the one or more memory modules cause the autonomous vehicle control system to perform at least the following when executed by the one or more processors generate feedback using the one or more feedback devices; and
the feedback is based on the confidence score associated with the individual roadway segment.

13. A method of operating a vehicle, the method comprising:
determining, using a location device communicatively coupled to one or more processors, an individual roadway segment on which the vehicle is located;
accessing, using the one or more processors, a confidence score associated with the individual roadway segment, wherein the confidence score is stored in one or more memory modules communicatively coupled to the one or more processors;
outputting one or more vehicle control signals from an automated drive controller communicatively coupled to the vehicle, wherein the one or more vehicle control signals are based on one or more vehicle control settings of an individual autonomous operation profile associated with the confidence score; and
operating the vehicle based on the one or more vehicle control signals output by the automated drive controller.

14. The method of claim 13, further comprising:
receiving a sensor signal from one or more observation sensors communicatively coupled to the one or more processors and the one or more memory modules, wherein the sensor signal comprises roadway information regarding a vehicle operating environment in which the vehicle and the individual roadway segment is located; and
increasing the confidence score associated with the individual roadway segment based on the roadway information.

15. The method of claim 13, further comprising:
comparing the confidence score to a threshold confidence score;
operating the vehicle based on an aggressive autonomous operation profile when the confidence score is at or above the threshold confidence score; or
operating the vehicle based on a conservative autonomous operation profile when the confidence score is below the threshold confidence score, wherein:
the one or more vehicle control signals comprise an acceleration control signal, a deceleration control signal, or both, that, control an acceleration rate of the vehicle, a deceleration rate of the vehicle, or both; and
a magnitude of the acceleration rate, the deceleration rate, or both, of the vehicle based on the conservative autonomous operation profile is less than a magnitude of the acceleration rate, the deceleration rate, or both, of the vehicle based on the aggressive autonomous operation profile.

16. The method of claim 13, further comprising generating feedback regarding the confidence score associated with the individual roadway segment using one or more feedback devices communicatively coupled to the one or more processors.

17. The method of claim 13, further comprising
receiving temporal information, weather information, and/or traffic information, and
altering the confidence score associated with the individual roadway segment based on one or more of the temporal information, the weather information, and the traffic information.

18. A method of operating a vehicle, the method comprising:
monitoring, using one or more observation sensors communicatively coupled to one or more processors and one or more memory modules, a vehicle operating environment of a vehicle as the vehicle travels along a first roadway segment located in the vehicle operating environment;
outputting a sensor signal comprising roadway information regarding the vehicle operating environment from the one or more observation sensors, such that the roadway information is received by the one or more memory modules;
storing the roadway information in the one or more memory modules, wherein the one or more memory modules also store:
a plurality of autonomous operation profiles, each comprising one or more vehicle control settings for an automated drive controller communicatively coupled to the vehicle; and
a plurality of confidence scores associated with a plurality of roadway segments, wherein:
an individual confidence score is associated with each individual roadway segment of the plurality of roadway segments such that a first confidence score is associated with the first roadway segment; and
each confidence score is associated with an individual autonomous operation profile of the plurality of autonomous operation profiles; and
increasing the first confidence score based on the roadway information regarding the vehicle operating environment of the first roadway segment such that the first confidence score comprises a first updated confidence score.

19. The method of claim 18, further comprising
outputting one or more vehicle control signals from the automated drive controller, wherein the one or more vehicle control signals are based on one or more vehicle control settings of an individual autonomous operation profile associated with the first updated confidence score; and
operating the vehicle along the first roadway segment based on the one or more vehicle control signals output by the automated drive controller.

20. The method of claim 19, wherein:
the one or more vehicle control signals based on the one or more vehicle control settings of the autonomous operation profile associated with the first updated confidence score comprise an acceleration control signal that controls an acceleration rate of the vehicle; and
the first updated confidence score is greater than the first confidence score such that the acceleration rate stored in the one or more vehicle control settings of the autonomous operation profile associated with the first updated confidence score is greater than an acceleration rate stored in the one or more vehicle control settings of an autonomous operation profile associated with the first confidence score.
